(19) United States
(12) Patent Application Publication
(10) Pub. No.: US 2007/0228672 A1
(43) Pub. Date: Oct. 4, 2007

(54) Multi-size fast connector

(76) Inventor: Ping Wen Huang, Wurih Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/396,689

(22) Filed: Apr. 4, 2006

(51) Int. Cl. B23B 31/12

(52) U.S. Cl. 279/58

(57) ABSTRACT

A multi-size fast connector including a main body, a holding unit and a slide unit. The main body is formed with a socket at a front end, in which a tool bit can be inserted. The holding unit serves to fixedly hold the tool bit. The slide unit serves to push the holding unit to firmly hold various sizes of tool bits. It is easy to fast connect various tool bits with the fast connector and disconnect the tool bits from the fast connector.

### BACKGROUND OF THE INVENTION

The present invention is related to a multi-size fast connector. It is easy to fast connect different tool bits with the fast connector and disconnect the tool bits from the fast connector. In addition, various sizes of tool bits can be firmly fixed with the fast connector.

FIGS. 5 to 7 show a conventional fast connector. The fast connector has a main body 7 formed with a spiral groove 71. A spring 72 is fitted around the main body 7. A straight section 721 of the spring 72 is inlaid in the spiral groove 71. The straight section 721 protrudes into the receiving cavity 73 of the main body 7 for engaging in a groove 81 of a tool bit 8.

When the tool bit 8 is inserted into the receiving cavity 73, the straight section 721 is pushed outward. When the groove 81 of the tool bit 8 reaches the straight section 721, the straight section 721 will be inlaid in the groove 81 of the tool bit 8 to locate the same. When the slide sleeve 74 is moved, the straight section 721 is pushed back into the spiral groove 71. At this time, the tool bit 8 is bounded out by the resilient member 75 disposed on the bottom of the receiving cavity 73.

In the above conventional fast connector, it is necessary to form the spiral groove 71 on the main body 7. It is troublesome to process the main body 7 to form the spiral groove 71. In addition, it is hard to control the precision of the spiral groove 71. Consequently, the straight section 721 of the spring 72 can be hardly truly located. In the case that the straight section 721 over-protrudes into the receiving cavity 73, when the tool bit 8 is inserted into the receiving cavity 73, the spring 72 tends to be clogged by the wall of the receiving cavity 73. Therefore, it will be hard to insert the tool bit 8 into the receiving cavity 73. When unplugging the tool bit 8, the spring 72 also tends to be clogged by the wall of the receiving cavity 73. Therefore, it will be also hard to extract the tool bit 8 out of the receiving cavity 73. In the case that the straight section 721 under-protrudes into the receiving cavity 73, the straight section 721 can be hardly firmly engaged in the groove 81 of the tool bit 8. Under such circumstance, the tool bit 8 is easy to slip out of the receiving cavity 73 in operation.

An improved fast connector 9 as shown in FIGS. 8 and 9 has been developed to solve the above problem. The fast connector 9 includes a main body 91, a locating unit 92 and a slide unit 93. The main body 91 is formed with a socket 911 in which a screwdriver bit 94 can be inserted. The bottom of the socket 911 is formed with a cavity 912 in which a part of a spring 913 is received. The other part of the spring 913 protrudes from the cavity 912 for bounding out the screwdriver bit 94. The wall of the socket 911 of the main body 91 is formed with an axial slot 914 in which the locating unit 92 is accommodated. The locating unit 92 is composed of a steel ball 921 and a resilient member 922. The resilient member 922 is mounted in the axial slot 914. The slide unit 93 is composed of a slide sleeve 931, a resilient member 932 and a C-shaped retainer ring 933. The slide sleeve 931 is fitted around the main body 91. The slide sleeve 931 is formed with two annular grooves 934 corresponding to the steel ball 921. A stop section 935 is formed between the two annular grooves 934 for abutting against the steel ball 921. By means of moving the slide sleeve 931, the steel ball 921 can engage with the screwdriver bit 94 or disengage therefrom to easily and fast connect the screwdriver bit 94 with the fast connector 9 or disconnect the screwdriver bit 94 from the fast connector 9.

However, the above fast connector still has some shortcomings as follows:

1. The fast connector is inapplicable to some sizes of tool bits. The tool bits have different shapes such as the shapes of square, hexagon and circle. The conventional fast connector employs a steel ball to fix the tool bits. In the case of different shapes of tool bits, the fast connector may be unable to fix the tool bits. Therefore, the application range of the conventional fast connector is limited.

2. The manufacturing cost is relatively high. The tool bit must be formed with an annular groove for the steel ball to engage with the tool bit. It is troublesome to process the tool bit to form the annular groove. Therefore, the manufacturing cost is increased.

### SUMMARY OF THE INVENTION

It is therefore a primary object of the present invention to provide a multi-size fast connector. It is easy to fast connect various tool bits with the fast connector and disconnect the tool bits from the fast connector. In addition, various sizes of tool bits can be firmly fixed with the fast connector.

According to the above object, the multi-size fast connector of the present invention includes: a main body formed with a socket at a front end, in which a tool bit can be inserted, a wall of the socket being formed with several slots at equal intervals, an annular groove being formed on an outer circumference of the wall of the socket between the slots and the front end, in which a retainer ring is inlaid, the retainer ring serving to connect a collar fitted around the socket with the main body, a rear end of the main body being sequentially formed with a first annular groove and a connecting section; a holding unit disposed between the socket and the collar for holding the tool bit; and a slide unit fitted between the main body and the collar for pushing the holding unit.

The present invention can be best understood through the following description and accompanying drawings wherein:

### BRIEF DESCRIPTION OF THE DRAWINGS

FIG. 1 is a perspective exploded view of the fast connector of the present invention;

FIG. 2 is a perspective assembled view of the fast connector of the present invention;

FIG. 3 is a sectional view of the fast connector of the present invention in one state;

FIG. 4 is a sectional view of the fast connector of the present invention in another state;

FIG. 5 is a sectional view of a conventional fast connector in one state;

FIG. 6 is a sectional view of the conventional fast connector in another state;

FIG. 7 is a sectional view of the conventional fast connector in still another state;

FIG. 8 is a perspective exploded view of another conventional fast connector; and

FIG. 9 is a sectional assembled view of the conventional fast connector of FIG. 8.

### DETAILED DESCRIPTION OF THE PREFERRED EMBODIMENTS

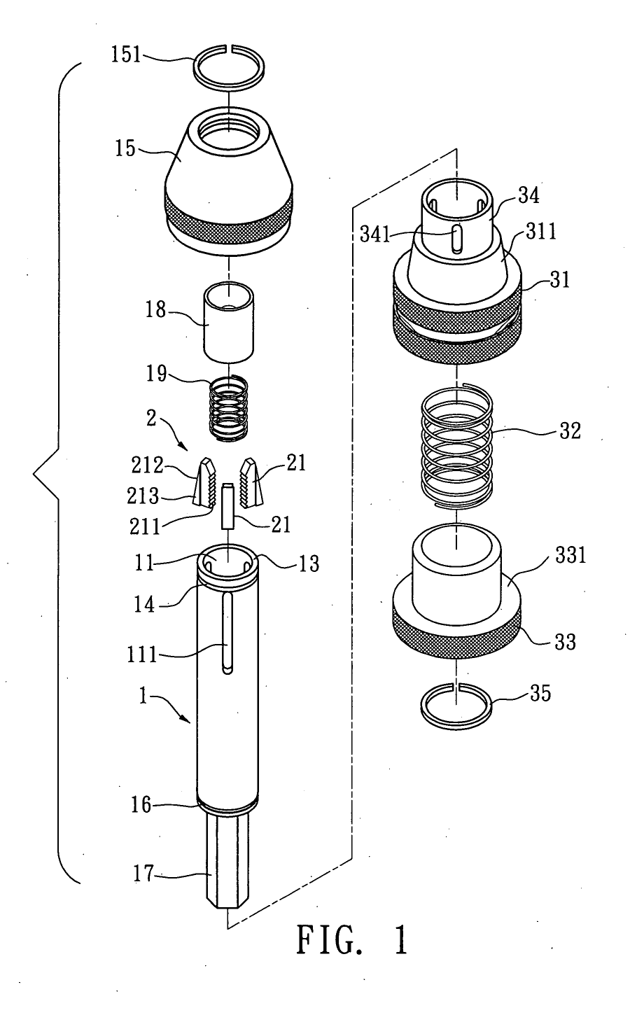

Please refer to FIG. 1. The multi-size fast connector of the present invention includes a main body 1 formed with a socket 11 at a front end 13, in which a tool bit 12 can be inserted. The wall of the socket 11 is formed with several slots 111 at equal intervals. A cap 18 and a second spring 19 are sequentially accommodated in the socket 11 from the front end to a rear end. An annular groove 14 is formed on an outer circumference of the wall of the socket 11 between the slots 111 and the front end 13, in which a retainer ring 151 is inlaid. The retainer ring 151 serves to connect a collar 15 fitted around the socket 11 with the main body 1. In this embodiment, the interior of the collar 15 is tapered from the rear end to the front end. The rear end of the main body 1 is sequentially formed with a first annular groove 16 and a connecting section 17.

The fast connector of the present invention further includes a holding unit 2 disposed between the socket 11 and the collar 15 for holding a tool bit 12. In this embodiment, the holding unit 2 is composed of several clamping blocks 21 fitted in the slots 111. Each clamping block 21 has a ratchet section 211 on one side facing the socket 11. The other side of the clamping block 21 is formed with a slope 212 slidable along an inner circumference of the collar 15. Two sides of the slope 212 are formed with widening sections 213, whereby the clamping block 21 can slide within the slot 111 without dropping into the socket 11.

The fast connector of the present invention further includes a slide unit 3 fitted between the main body 1 and the collar 15 for pushing the holding unit 2.

In this embodiment, the slide unit 3 includes a slide sleeve 31, a spring 32 and a fixing member 33. The slide sleeve 31 has a conic section 311 adapted to the tapered interior of the collar 15. A skirt section 34 forward extends from a front end of the conic section 311. The skirt section 34 is formed with several slots 341 corresponding to the slots 111 of the socket 11. An inner circumference 312 of the conic section 311 is correspondingly fitted around the outer circumference of the socket 11. A first stop section 313 is formed behind the inner circumference 312 of the conic section 311 for stopping the spring 32. An outer circumference of the fixing member 33 is formed with a second stop section 331. An inner circumference of the fixing member 33 is formed with a second annular groove 333 corresponding to the first annular groove 16. A second retainer ring 35 is inlaid in the first and second annular grooves 16, 333 for fixing the fixing member 33 with the main body 1.

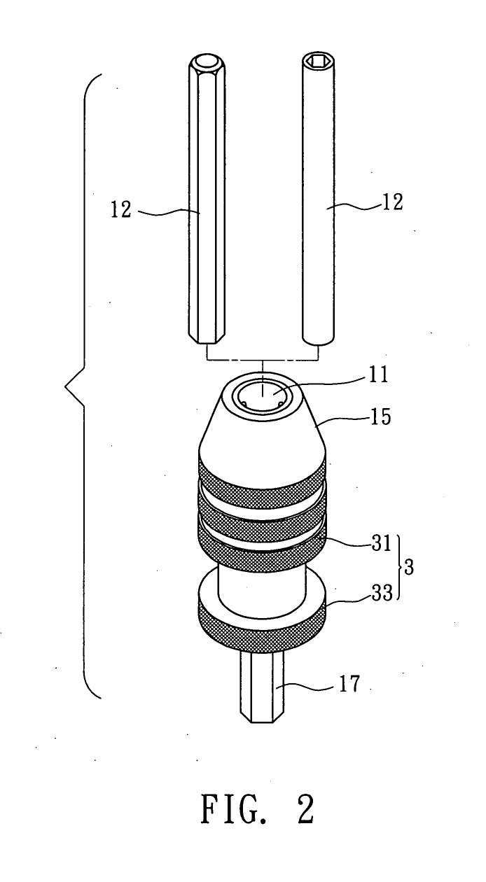

When assembled, first, the clamping blocks 21 are fitted through the slots 111. Then by means of the retainer ring 151, the collar 15 is fixed with the socket 11. The inner wall face of the collar 15 abuts against the clamping blocks 21 to make the ratchet sections 211 of the clamping blocks 21 protrude into the socket 11. The slide sleeve 31, the spring 32 and the fixing member 33 are then sequentially fitted on the main body 1 as shown in FIG. 2. The spring 32 resiliently pushes the slide sleeve 31, whereby the slide sleeve 31 will axially forward push the clamping blocks 21 to contract the clamping blocks 21 in normal state.

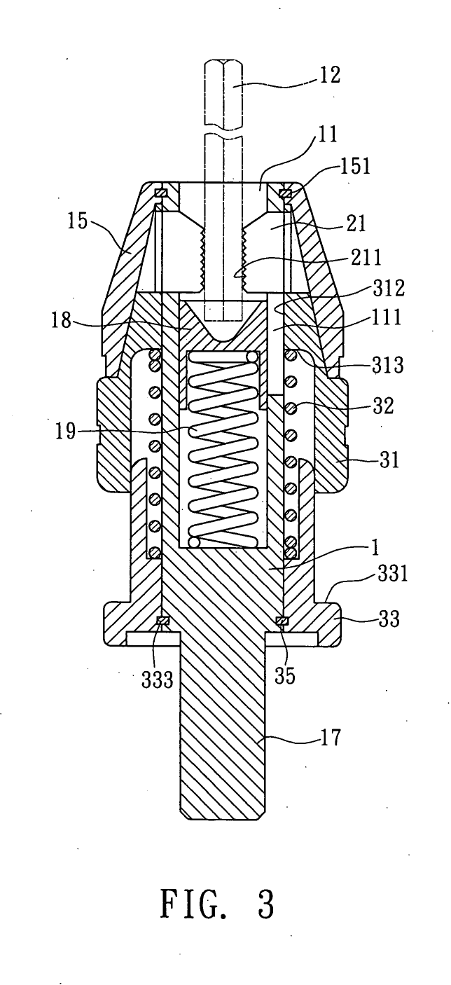

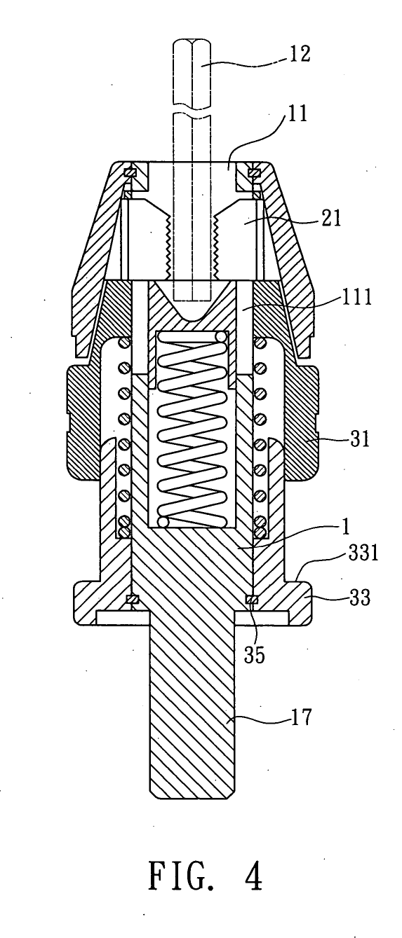

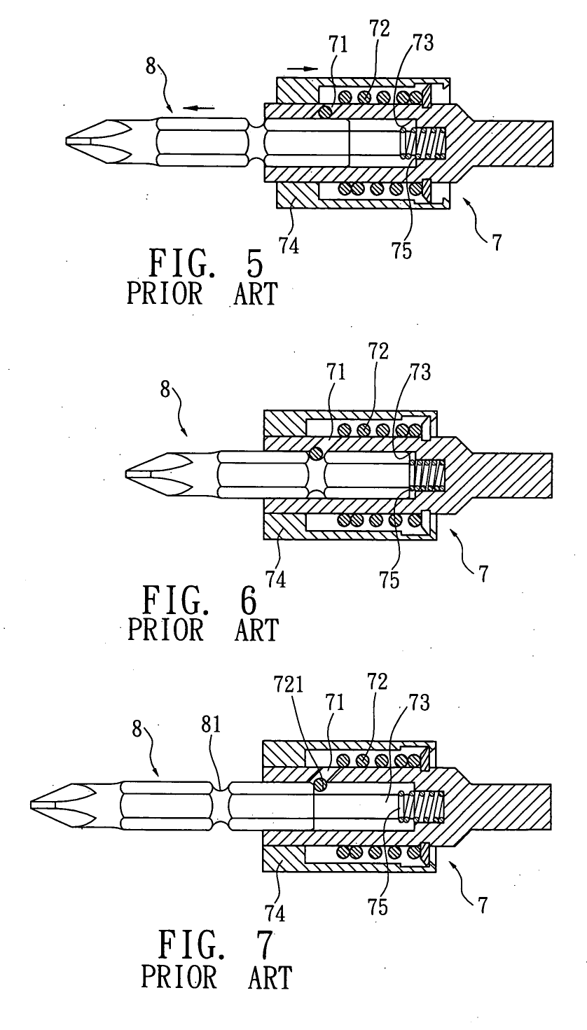

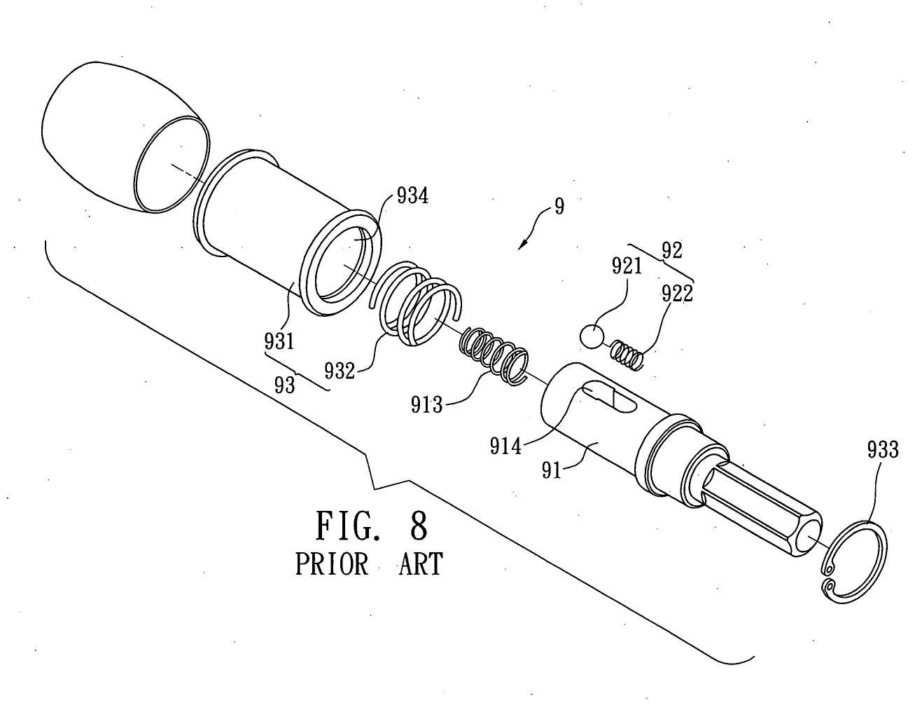

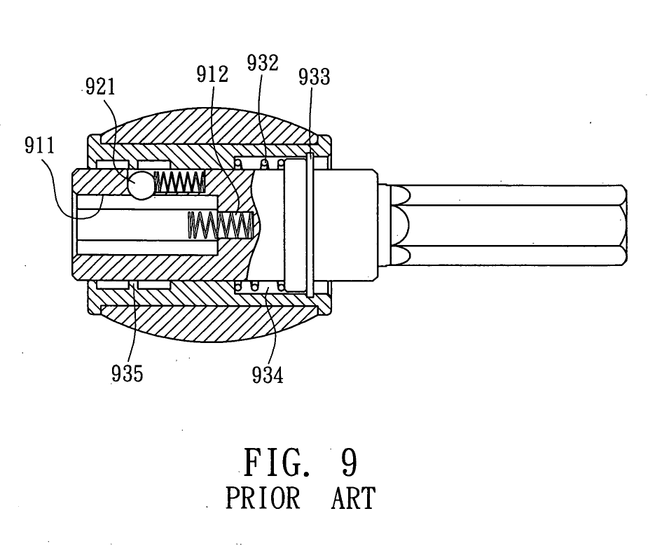

In use, as shown in FIG. 3, when a tool bit 12 is to be inserted into the socket 11, the slide sleeve 31 is pulled backward. At this time, the clamping blocks 21 are released and stretchable. Under such circumstance, the tool bit 12 can be inserted into the socket 11. Then the slide sleeve 31 is released. At this time, the slide sleeve 31 is resiliently pushed forward by the spring 32 to again forward push the clamping blocks 21 and contract the clamping blocks 21. Under such circumstance, the clamping blocks 21 fixedly hold the tool bit 12. When it is desired to take off the tool bit 12, the slide sleeve 31 is moved backward to slightly loosen the clamping blocks 21 as shown in FIG. 4. At this time, the clamping blocks 21 can be stretched to release the tool bit 12. Under such circumstance, the tool bit 12 can be replaced. Therefore, it is easy to connect the tool bit 12 with the fast connector and disconnect the tool bit 12 from the fast connector.

The tool bit 12 is fixedly held by the ratchet sections 211 of the clamping blocks 21 instead of the steel ball of the prior art. The fast connector of the present invention is applicable to various sizes of tool bits.

Moreover, since the tool bits are fixed by means of the ratchet sections 211 of the clamping blocks 21 instead of the steel ball, it is no more necessary to process the tool bits to form a groove thereon for receiving the steel ball. Therefore, the processing cost is saved.

The above embodiments are only used to illustrate the present invention, not intended to limit the scope thereof. Many modifications of the above embodiments can be made without departing from the spirit of the present invention.

What is claimed is:

1. A multi-size fast connector comprising:
a main body formed with a socket at a front end, in which a tool bit can be inserted, a wall of the socket being formed with several slots at equal intervals, an annular groove being formed on an outer circumference of the wall of the socket between the slots and the front end, in which a retainer ring is inlaid, the retainer ring serving to connect a collar fitted around the socket with the main body, a rear end of the main body being sequentially formed with a first annular groove and a connecting section;
a holding unit disposed between the socket and the collar for holding the tool bit; and
a slide unit fitted between the main body and the collar for pushing the holding unit.

2. The multi-size fast connector as claimed in claim 1, wherein an interior of the collar is tapered from the rear end to the front end.

3. The multi-size fast connector as claimed in claim 1, wherein the holding unit is composed of several clamping blocks fitted in the slots.

4. The multi-size fast connector as claimed in claim 3, wherein each clamping block has a ratchet section on one side facing the socket, the other side of the clamping block being formed with a slope slidable along an inner circumference of the collar, two sides of the slope being formed with widening sections, whereby the clamping block can slide within the slot without dropping into the socket.

5. The multi-size fast connector as claimed in claim 1, wherein the slide unit includes a slide sleeve, a spring and a fixing member.

6. The multi-size fast connector as claimed in claim 5, wherein the slide sleeve has a conic section adapted to the tapered interior of the collar, a skirt section forward extending from a front end of the conic section, the skirt section being formed with several slots corresponding to the slots of the socket, an inner circumference of the conic section being correspondingly fitted around the outer circumference of the socket, a first stop section being formed behind the inner circumference of the conic section for stopping the spring, an outer circumference of the fixing member being formed with a second stop section, an inner circumference of the fixing member being formed with a second annular groove corresponding to the first annular groove, a second retainer ring being inlaid in the first and second annular grooves for fixing the fixing member with the main body.

7. A multi-size fast connector comprising:
a main body formed with a socket at a front end, in which a tool bit can be inserted, a wall of the socket being formed with several slots at equal intervals, an annular groove being formed on an outer circumference of the wall of the socket between the slots and the front end, in which a retainer ring is inlaid, the retainer ring serving to connect a collar fitted around the socket with the main body, a rear end of the main body being sequentially formed with a first annular groove and a connecting section;
a holding unit disposed between the socket and the collar for holding the tool bit, the holding unit being composed of three clamping blocks fitted in the slots for holding a tool bit; and
a slide unit fitted between the main body and the collar for pushing the holding unit.
